(19) United States
(12) Patent Application Publication
(10) Pub. No.: US 2006/0121811 A1
(43) Pub. Date: Jun. 8, 2006

(54) Composite material for producing a layer of hygienic article that comes into physical contact with the body and a corresponding hygienic article

(75) Inventors: Rainer Mangold, Herbrechtingen (DE); Krzysztof-Daniel Malowaniec, Heidenheim (DE); Petra Eckel, Heidenheim (DE)

Correspondence Address: YOUNG & BASILE, P.C., 3001 WEST BIG BEAVER ROAD, SUITE 624, TROY, MI, 48084, US

(73) Assignee: PAUL HARTMANN AG, HEIDENHEIM (DE)

(21) Appl. No.: 11/336,232

(22) Filed: Jan. 20, 2006

Related U.S. Application Data
(63) Continuation of application No. 10/089,561, filed on May 28, 2002, now abandoned.

(30) Foreign Application Priority Data
Oct. 2, 1999 (DE) 199 47 582.2

(51) Int. Cl. D04H 13/00; B32B 5/26; D04H 1/00; D04H 3/00; D04H 5/00; D02G 3/00; B32B 5/06; B32B 27/02

(52) U.S. Cl. 442/392; 442/361; 442/364; 442/389; 442/340; 442/347; 442/351; 428/374

(57) ABSTRACT

A composite material for producing a layer of a disposable hygienic article that comes into physical contact with the body including a first body-contacting layer and a second layer. The first body contacting layer is composed of monocomponent and bicomponent fibers having a denier of 3.5 dtex or less. The second layer is composed of between 40 and 100 percent bicomponent fibers having a denier of 4 to 10 dtex with a lower melting point component lower than the melting point of the monocomponent fibers of the first layer.

This application is a continuation of U.S. Ser. No. 10/089,561 filed May 28, 2002, which claims priority under 35 U.S.C. § 371 to PCT/EP00/09537

### BACKGROUND

The invention relates to a composite material for producing a layer of a disposable hygiene article that comes into physical contact with the body from at least two non-woven material layers joined by a thermal process.

Multiple-layer composite materials of this type, as well as hygienic articles with a layer consisting of such a composite material that comes into physical contact with the body, usually described as the top sheet, are known. The layer coming into physical contact with the body usually covers a retaining element located under it, which thus does not come into physical contact with the body, in which the bodily fluid discharged by the user is to be retained, which in the case of modem hygienic articles is primarily achieved by means of superabsorbent materials inside the retaining element.

Severe demands are made on composite materials of the type under discussion with respect to rapid fluid absorption capability even with repeated sudden saturation. Impinging fluid must be prevented from collecting on the surface (pooling) and escaping towards the sides, instead the impinging fluid should be absorbed by the layer coming into physical contact with the body and channeled in the direction of the retaining element . A distribution effect within the layer is also desirable. Furthermore, reverse wetting of the composite material, specifically with the exertion of pressure such as can be caused by the body weight of a user when sitting, should be as low as possible. The composite material should perform a bracing function between the absorbent retaining element of a hygiene article and the skin surface.

The surface which is in physical contact with the skin of the user should be experienced as soft and pleasant, which can be achieved by the use of extremely fine fibers. The use of extremely fine fibers on the other hand conflicts with the attempt to achieve the greatest possible resilience in the characteristics of the composite material. This is understood to mean the ability of the composite material to bring a high springback force to bear against external compressive forces or at least to resume almost its original condition following saturation and/or compression.

U.S. Pat. No. 5,257,982 describes a composite material for producing a layer that comes into physical contact with the body in an absorptive hygiene article which is formed from at least two non-woven material layers, where each non-woven material layer has a primary layer which comes into physical contact with the body and a second layer positioned under it, which therefore does not come into physical contact with the body. The fiber thickness of the second layer positioned not to come into physical contact with the body is less than the fiber thickness of the first layer positioned so that it comes into physical contact with the body. The publication teaches positioning layers of greater fiber thickness in physical contact with the body and layers of lesser thickness not in physical contact with the body. In the case of several layers, the layers are arranged in order of progressively decreasing fiber thickness. The layers can comprise thermoplastic fibers of polyamides, polyolefins or polypropylenes, fibers of low-melting polyester are also mentioned.

EP 0 372 572 A2 describes polyester binding fibers for thermally bonding non-woven fiber materials which have a relatively low melting point in the range between 160° and 220° Celsius.

From EP-A-0 859 883 B1 a plurality of composite materials is known with at least two layers of non-woven material, which can also be used to produce a layer for a hygienic article that comes into physical contact with the body. This publication is concerned with improving the fluid absorption and distribution characteristics of the composite material as the top sheet in a hygienic article, specifically transfer times and reverse wetting characteristics are to be improved. Two- or three-layer composite materials in highly varied combinations of layers are disclosed, as part of which mixtures of synthetic bonding fibers and matrix-forming fibers are utilized.

### SUMMARY

The object of the present invention is to further improve a composite material of the type described above, taking into consideration the previously described general requirements for a top sheet material, with respect to the strength of the fiber composite, namely, between the fibers of a non-woven layer but also between at least two non-woven layers, and with respect to the tendency of the composite material to give off particulates (fibers or parts of fibers) into the environment when it is handled (powdering). It was ascertained that composite materials on a non-woven base create very high levels of dust when they are handled and especially when handled in high-speed manufacturing and processing machinery, e.g., those for the production of absorbent hygienic articles. The present invention is intended to counteract this additional problem and thereby improve the processing properties of composite materials from non-woven layers. Furthermore, any migration to the outside of the frequently granular superabsorbent polymer materials from the retaining element through the layer coming into physical contact with the body is to be prevented.

This object is accomplished by a composite material of at least two non-woven layers joined by a thermal process, wherein the upper layer in physical contact with the body is formed from a mixture of mono-component fibers and bi-component fibers and the proportion of bi-component fibers amounts to 30 to 70% by weight of the upper layer, and where the denier of the fibers in the upper layer is at most 3.5 dtex, and where the lower layer comprises at least 40% by weight bi-component fibers, whose higher melting component is made of PET (polyester) and whose lower melting component has a lower melting point than that of the mono-component fibers of the upper layer, and where the denier of the bi-component fibers of the lower layer is between 4 and 10 dtex.

The bi-component fibers, whose lower melting component forms a binding agent through a thermal process, result in an improvement in internal strength, i.e., the cohesion of the fibers one to the other but also of the fibers between the layers. As the result of incorporating higher melting, extremely fine, and therefore, extremely thin mono-component fibers in the upper layer in physical contact with the body, in addition to bi-component fibers, the upper layer is felt to be soft and pleasant. A percentage of from 30 to 70% by weight for the bi-component fibers has proven to be conducive to reaching the objective. If too few fine mono-component fibers are used in the upper layer which remain untouched by the thermal process, the layer would be experienced as being too hard. If too few bi-component fibers are used which result in the fibers being linked through the thermal process, the bond within the layer is inadequate. By selecting the denier of the fibers in the upper layer at a maximum of 3.5 dtex, not only the aspect of a pleasant sensation when worn is satisfied, but an additional problem is solved very effectively. Migration of granular superabsorbent particulate material to the surface of the hygienic article is hereby prevented. Consequently, additional protective layers in the form of thin paper-like layers or the like for the retaining element containing superabsorbent materials can be dispensed with.

With the invention it was recognized that the dust problem mentioned above has its basis in conflicting goals. In the fiber composite the one minimum lower layer is primarily supposed to provide adequate capacitative volume to ensure rapid absorption of fluid and to function as a spacer between the (wet) retentive absorptive element and the inside of the diaper. This is achieved on the one hand by the use of relatively stiff, resilient fibers, and, on the other hand, by the fact that the lower layer undergoes no or only very minor compression during the thermal bonding. The result of these circumstances is that during the thermal bonding relatively few fibers come into contact with each other. The dust problem results from this during the further processing of the composite material. Inadequately bonded fibers and fiber parts have a tendency to detach themselves from the fiber composite.

By selecting a special bi-component fiber with PET (polyester) (or with a polymer equivalent to PET with respect to the resiliency characteristics of such bi-component fibers) as a higher-melting component in a proportion of at least 40% with a simultaneous selection of a fiber thickness between 4 and 10 dtex, both adequate rigidity or resiliency of the composite material as well as outstanding bonding of the fibers to each other is achieved.

The PET core of these bi-component fibers provides adequate fiber stiffness and consequently the necessary resiliency and maintenance of a large capacitative volume. If too few bi-component fibers with PET (polyester) as higher melting component are used, the lower layer either has too little resiliency (in the event that another bi-component fiber is used, for example, PP/PE (polypropylene, polyethylene) bi-component fibers), or the fibers in the lower layer are not adequately bonded to each other following thermofusion (in the event that a resilient mono-component fiber is used as an additional fiber component). The latter configuration would promote the dust problem described above during further processing of the composite material.

EP-A-0 859 883 B1 mentioned above, does mention a plurality of combinations for the individual layers of the non-woven composite material. Only a few embodiments include bi-component fibers with PET (polyester) as the higher melting component. The combinations of layers however diverge in many other parameters from the combination claimed here. The advantageousness of bi-component fibers of this type in the combination of layers claimed was neither recognized nor suggested.

In an advantageous further development of the invention the upper layer in physical contact with the body has an textured pattern created by calendering, where the percentage of the textured pattern covers 5 to 30%, preferably 15 to 25% of the total area of the composite material. Calendering further increases the strength within the composite material. Impermeability with respect to an involuntary escape of superabsorbent particulate materials, which must therefore be prevented, is also improved.

It has furthermore proved to be advantageous if the upper layer is configured with a surface weight of 10 to 30, preferably of 15 to 20 g/m². The rate of fluid absorption is adequate with this surface weight and the layer can still be produced economically.

The rate of fluid absorption is positively influenced even more by making the fibers of the upper layer hydrophilic.

In a further development of the invention the lower layer comprises at least 60% by weight, preferably at least 80% by weight, bi-component fibers, whose higher melting component is composed of PET (polyester). In an especially preferable form, the lower layer consists 100% of such bi-component fibers. The higher the percentage of these bi-component fibers as selected under the invention in the lower layer of the non-woven composite material, the more resilient the composite material proves to be, while at the same time exhibiting a higher potential for inter-fiber bonding.

Bi-component fibers can be produced in a known way as side-by-side fiber, as sheath/core, or also as matrix fibers with an inlaid filament-like lower melting component. The bi-component fibers with PET (polyester) as higher melting component is preferably configured as a sheath/core fiber with a core located eccentrically to the longitudinal central direction of the fiber. The thickness of the sheath/core bi-component fibers in a further development of the invention is 5 to 8 dtex and in accordance with a particularly preferred embodiment 6 to 7 dtex.

In accordance with a further advantageous embodiment of the invention, the lower melting component of the bi-component fiber present at least 40 percent by weight in the lower layer is formed of PE (polyethylene). The specific combination of PET as higher melting component and PE as lower melting component has proven to be advantageous, since in such a case the weldability with other components of absorbent hygienic articles, for example the back sheet normally made of PP or PE, is made easier.

The further object of the present invention is to improve a hygienic article having a fluid-tight layer not in physical contact with the body in use, a retaining element and a fluid-permeable layer provided on the side of the retaining element in physical contact with the body, both with respect to fluid absorption and distribution properties and low reverse wetting characteristics as well with respect to the dust problem mentioned above and also the barrier effect of the layer not in physical contact with the body to prevent superabsorbent particulate materials from escaping to the surface of the hygienic article.

This object is accomplished by a hygienic article, wherein the retaining element comprises a layer of intralinked cellulose fibers with a fluid retention value between 0.6 and 0.9 g_{Fl}/g_{Fiber}, where the layer of intralinked cellulose fibers contains 8-15% by weight of superabsorbent polymer materials, where the fluid-permeable layer provided on the side of the retaining element in physical contact with the body for its part is at least two layers and the upper of these layers consists of fibers with a denier of at most 3.5 dtex, while the lower of these layers comprises bi-component fibers with a denier between 4 and 10 dtex, whose higher melting component is made of PET.

The fluid retention capability of the linked and non-linked natural cellulose fibers is determined by the following centrifuge test giving the previously mentioned fluid retention value. A layer of cellulose fibers to be analyzed is weighed in a dry state to determine its mass in grams. The samples are then immersed completely for 30 minutes in a one-percent sodium chloride solution of demineralized water as the test solution and then centrifuged for 4 minutes at 276 times the speed of gravitational acceleration. Then the specimens are weighed again to determine the mass, including the bound fluid. The mass of the fluid absorbed or bound is found from the difference between the mass determined after centrifuging and the dry mass of the fiber material to be analyzed. If this difference is divided by the dry mass a retention value is obtained in g_{Fl}/g_{Fiber}.

As the result of the retaining element having a layer of intralinked cellulose fibers with 8 to 15% by weight of this layer comprising superabsorbent polymer materials, one effect is to prevent the retaining element from collapsing when impacted by fluid, since intralinked cellulose fibers expand when impacted by fluid rather than collapsing in on themselves, which is generally known and utilized in modem hygienic articles. The second effect is that fluid remaining in the retaining element is bound there as the result of the inventive high percentage of superabsorbent polymer materials in this layer of the retaining element preferably in physical contact with the body. The reverse wetting characteristics of the retaining element and consequently of the hygienic article are markedly improved, since even under exertion of pressure, such as the body weight of a user of the hygienic article, any still remaining fluid still present in this layer cannot reach the user's skin surface since it is adequately bonded by the superabsorbent materials in this layer.

By further developing the fluid-permeable layer, provided as at least two layers on the side of the retaining element in physical contact with the body, that is the top sheet of the hygienic article, so that the upper of these layers consists of fibers with a denier of 3.5 dtex at most, while the lower of these layers comprises bi-component fibers with a denier between 4 and 10 dtex, whose higher melting component is formed of PET (polyester), one effect—as discussed at the beginning in connection with the composite material under the invention—is to convey a pleasant feeling during use because of the extremely fine fibers in the layer in physical contact with the skin, and the other effect is that good fiber cohesion is achieved, with good resiliency characteristics in the lower layer and absolute impermeability to the escape of superabsorbent particulate materials.

In this aspect of the invention the retaining element has in addition a layer of non-linked cellulose fibers with a fluid retention value between 1.0 and 1.4 g_{Fl}/g_{Fiber} and at least 20% by weight, preferably at least 40% by weight superabsorbent polymer materials. This layer is located below the layer of the retaining element formed from intralinked cellulose fibers, thus not in physical contact with the body.

Furthermore it has proven to be advantageous if the previously mentioned additional layer of the retaining element is constructed in two layers, by the additional layer having a layer essentially free of superabsorbent materials on the side not in physical contact with the body in use. This essentially SAP-free layer, which has at most 20% by weight, preferably at most 10% by weight of superabsorbent materials, functions almost as a blocker for granular superabsorbent particulate materials which are contained in very much higher concentration in the aforementioned retaining layer of the retaining element, towards the side not in physical contact with the body, where there is a risk that these occasionally sharp granules can damage the fluid-impermeable layer not in physical contact with the body (the back sheet).

### BRIEF DESCRIPTION OF THE DRAWING

Additional features, details and advantages of the invention can be found in the attached patent claims and the drawing and following description of preferred embodiments of the invention.

In the drawing:

FIG. 1 shows a schematic cross-section view of a dual-layer composite material under the invention;

FIG. 1a shows a textured pattern from the composite material; and

FIG. 2 shows a schematic cross-section view of a hygienic article under the invention.

### DETAILED DESCRIPTION

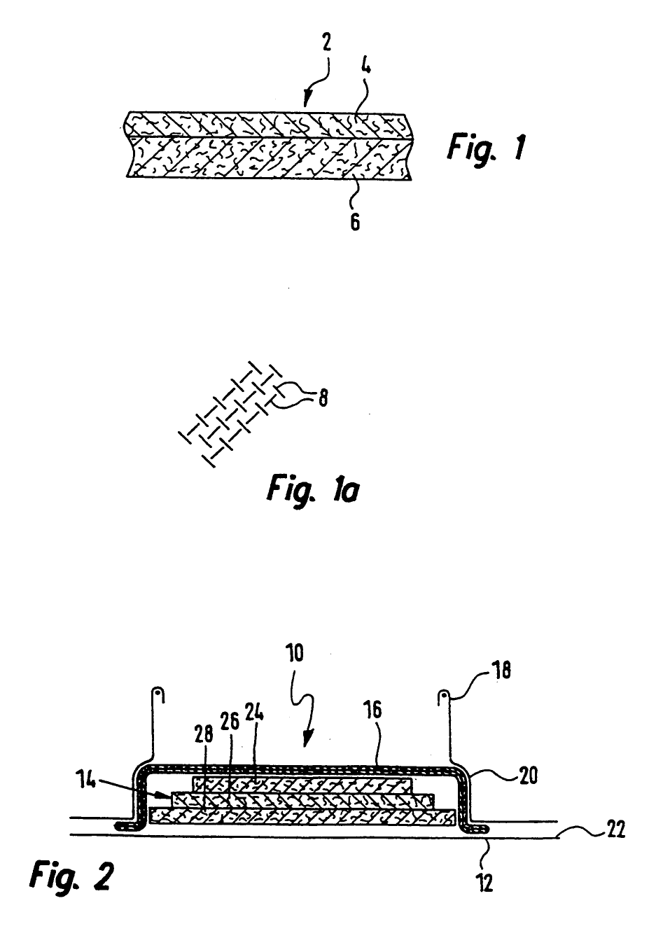

FIG. 1 shows in a schematic representation a composite material under the invention which can be used as a layer in physical contact with the body in a hygienic article. The composite material 2 comprises a first upper layer 4 of the hygienic article in physical contact with the body in use and a second lower layer 6 of the hygienic article not in physical contact with the body in use. The upper layer 4, which has a surface weight of 18 g/m², is formed of a carded non-woven material from a fiber mixture which is composed 60% by weight of polypropylene mono-component fibers with a denier of 2.2 dtex and 40% by weight of polypropylene/polyethylene bi-component fibers with a denier of 1.7 dtex. This layer was calendered, during which process a so-called “checkerboard textured pattern” was created, which has line sections 8 alternately offset to each other and aligned to each other in vertical directions as shown in FIG. 1a. The percentage of textured line sections 8 over the entire surface is about 20 percent.

The melting point of the PP mono-component fibers at about 160° C. is higher than that of the lower melting component PE of the PP/PE bi-component fibers at 110° C. The melting point of the higher melting PP component of the PP/PE bi-component fibers is about 140° C.

The lower layer 6, which has a surface weight of 12 g/m², comprises a high percentage of PET/PE bi-component fibers, which percentage was selected in the case of the preferred embodiment at 100%. The bi-component fibers have a fineness or thickness of 4.4 dtex. The melting point of the higher melting component PET (polyester) of the PET/PE bi-component fibers lies at about 260° C. The bi-component fiber is configured as sheath/core fiber with core of PET symmetrical to the longitudinal center direction of the fiber.

A bi-component fiber with a thickness of 6.7 dtex proves to be particularly suitable, preferably formed as sheath/core fiber with asymmetrical core (higher resiliency).

The lower layer 6 was configured as carded non-woven material. The previously calendered upper layer 4 and the lower layer 6 are positioned on top of one another and bonded together in an “air through process” by the thermal effect of hot air, in which the lower melting component of the bi-component fibers (PE in each case) is at least softened by the thermal effect and thus bonds the fibers of the individual layers to each other, but also bonds the fibers in an interface boundary area between the two non-woven material layers.

FIG. 2 shows in a schematic view a preferred embodiment of a hygienic article 10 of the invention with fluid-impermeable plastic layer 12 not in physical contact with the body, a triple-layer absorbent element 14 and a top sheet layer 16, which for its part is configured at least double-layered, covering the absorptive element on the side in physical contact with the body. In addition, the hygienic article includes on both sides of the absorptive element rib elements 20 furnished with means of elastification 18, which overlap the top sheet 16 towards the sides visible in the drawing and run flush to the edge as far as a longitudinal edge 22 of the plastic layer 12.

The retaining element 14 comprises a layer 24 furnished immediately below the top sheet layer 16 and in contact with it, which consists of linked cellulose fibers with a percentage of from 8 to 15% by weight with respect to the weight of this layer of superabsorbent materials. Below this first layer 24 is a second retaining element layer 26, which essentially consists of non-linked cellulose fibers with a percentage of more than 20% by weight of superabsorbent materials. A third layer 28 not in physical contact with the body, which can also be a partial layer of the second layer 26 and which likewise consists of natural non-linked cellulose fibers, but which has no superabsorbent materials, follows this layer 26. This partial layer acts primarily as a barrier layer for granular superabsorbent particulate materials and prevents them from dropping further down towards the plastic layer. 12 and damaging it.

The top sheet layer 16 in physical contact with the body is, as already mentioned, configured in two layers, where the upper layer coming into direct physical contact with the body of a user of the hygienic article consists of fibers with a maximum denier of 3.5 dtex, while the lower of these layers includes bi-component fibers with a denier between 4 and 10 dtex, whose higher melting component is made of PET (polyester). This top sheet layer 16 is preferably configured like the composite material from FIG. 1.

What is claimed is:

1. A composite material for producing a layer of a disposable absorbent hygienic article that comes into physical contact with the body comprising:
a first body-contacting layer, the first body-contacting layer composed of between 30 wt % and 70 wt % monocomponent fibers, wherein the monocomponent fibers have a denier of at most 3.5 dtex and a monocomponent fiber melting point, and between 30 wt % and 70 wt % bicomponent fibers wherein the bicomponent fibers have a denier of at most 3.5 dtex;
a second layer joined to the first body-contacting layer, the second layer composed of between 40 wt % and 100 wt % bicomponent fibers, the bicomponent fibers having a denier between 4 and 10 dtex and having a higher melting component composed of PET and a lower melting component, the lower melting component having a melting point lower than the melting point of monocomponent fibers of the first body-contacting layer.

2. The composite material of claim 1 further comprising a junction region interposed between the first body-contacting layer and the second layer, the junction region comprising monocomponent fibers having a denier of at most 3.5 dtex, bicomponent fibers having a denier of at most 3.5 dtex, and bicomponent fibers having a denier of between 4 and 10 dtex, the junction region having melted portions of lower melting component of the bicomponent fibers having a denier between 4 and 10, unmelted monocomponent fibers having a denier of at most 3.5 dtex, and unmelted bicomponent fibers having a denier of at most 3.5 dtex.

3. The composite material in accordance with claim 1, characterized in that the first body-contacting layer has a textured pattern created by calendering, where the percentage of the textured surface comprises 5 to 30% of the total surface.

4. The composite material in accordance with claim 3, wherein the percentage of the textured surface comprises 15 to 25% of the total surface.

5. The composite material in accordance with claim 1, wherein the surface weight of the upper layer is about 10 to 30 g/m².

6. The composite material in accordance with claim 5, wherein the surface weight of the upper layer is about 15 to 20 g/m².

7. The composite material in accordance with claim 1, wherein the fibers of the upper layer are one of hydrophilic and made supple to be permanently hydrophilic.

8. The composite material in accordance with claim 1, wherein the lower layer comprises at least 60% by weight bi-component fibers whose higher melting component is made of PET.

9. The composite material in accordance with claim 8, wherein the lower layer comprises at least 80% by weight bi-component fibers whose higher melting component is made of PET.

10. The composite material in accordance with claim 9, wherein the lower layer consists of 100% of bi-component fibers whose higher melting component is made of PET.

11. The composite material in accordance with claim 1, wherein the bi-component fibers of the lower layer with PET as higher melting component is a sheath/core fiber.

12. The composite material in accordance with claim 11, wherein the sheath/core fiber has a core positioned eccentrically to the longitudinal center direction of the fiber.

13. The composite material in accordance with claim 12, wherein the denier of the sheath/core fiber is 5 to 8 dtex.

14. The composite material in accordance with claim 13, wherein the denier of the sheath/core fiber is 6 to 7 dtex.

15. The composite material in accordance with claim 1, wherein the lower melting component of the bi-component fiber present at least 40% by weight in the lower layer is made of polyethylene.

16. An absorbent hygienic article comprising:
a fluid tight layer;
a retaining element; and
a fluid permeable layer, the fluid permeable layer including a first body-contacting layer, a second layer, and a junction region interposed between the first body-contacting layer and the second layer, wherein the first body-contacting layer is composed of between 30 wt % and 70 wt % monocomponent fibers having a denier of at most 3.5 dtex and a monocomponent fiber melting point and between 30 wt % and 70 wt % bicomponent fibers having a denier of at most 3.5 dtex, wherein the second layer is compossed of between 40 wt % and 100 wt % bicomponent fibers, the bicomponent fibers having a denier between 4 and 10 dtex and having a higher melting point component composed of PET and a lower melting component, the lower melting component having a melting point lower than the melting point of monocomponent fibers of the first body-contacting layer, and wherein the junction region is composed of melted portions of the lower melting component of bicomponent fibers having a denier between 4 and 10, umnelted monocomponent fibers having a denier of at most 3.5 dtex and unmelted bicomponent fibers having a denier of at most 3.5 dtex.

17. An absorbent hygienic article having a
fluid-tight layer not in physical contact with the body during use, a retaining element and a fluid-permeable layer provided on the side of the retaining element in physical contact with the body, where the retaining element comprises one layer of intralinked cellulose fibers with a fluid retention value which is derived from the quotients of the mass (g_{Fl}) of the fluid absorbed and the dry mass (g_{Fiber}) of the cellulose fibers and is between 0.6 and 0.9 g_{Fl}/g_{Fiber}, wherein the layer of intralinked cellulose fibers contains 8-15% by weight of superabsorbent polymer materials, where the fluid-permeable layer provided on the side of the retaining element in physical contact with the body is at least double-layered and an upper of the double layers consists of fibers with a denier of at most 3.5 dtex, while a lower of the double layers comprises bi-component fibers with a denier between 4 and 10 dtex whose higher melting component is made of PET.

18. The absorbent hygienic article in accordance with claim 17, wherein the retaining element has in addition a layer of nonmeshed cellulose fibers with a fluid retention value which is made up of the quotients of the mass (g_{Fl}) of the fluid absorbed and the dry mass (g_{Fiber}) of the cellulose fibers and is between 1.0 and 1.4 g_{Fl}/g_{Fiber} and at least 20% by weight of superabsorbent polymer materials.

19. The absorbent hygienic article in accordance with claim 18, wherein the additional layer of the retaining element is disposed under the layer of intrameshed cellulose fibers.

20. The absorbent hygienic article in accordance with claim 19, wherein the additional layer has a layered area on the side not in physical contact with the body in use which is free of superabsorbent materials.
